(19) United States
(12) Patent Application Publication
(10) Pub. No.: US 2014/0335733 A1
(43) Pub. Date: Nov. 13, 2014

(54) ELECTRICAL CONNECTOR ASSEMBLY HAVING SIMPLIFIED RECEPTACLE TERMINALS

(71) Applicant: HON HAI PRECISION INDUSTRY CO., LTD., New Taipei (TW)

(72) Inventors: QIU QIAN, Kunshan (CN); JIAN-KUANG ZHU, Kunshan (CN); CHUN-SHENG LI, Kunshan (CN)

(73) Assignee: HON HAI PRECISION INDUSTRY CO., LTD., New Taipei (TW)

(21) Appl. No.: 14/273,561

(22) Filed: May 9, 2014

(30) Foreign Application Priority Data
May 9, 2013 (CN) 2013202476066

(51) Int. Cl. H01R 13/46

(52) U.S. Cl. CPC H01R 13/46
USPC 439/626

(57) ABSTRACT

An electrical connector assembly includes an receptacle connector, the receptacle connector includes a first insulative housing defining a mating surface and a first side surface extending along a first direction. A plurality of first terminals are retained in the first insulative housing and each defines a contacting plate fixed to the first insulative housing and a welding portion extending outside of the first insulative housing. The first insulative housing defines a plurality of mating holes running through the mating surface, a part of the contacting plate is exposed in the mating hole to form a contacting portion.

### BACKGROUND OF THE INVENTION

1. Field of the Invention

The present invention relates to an electrical connector assembly, and more particularly to an electrical connector assembly having a plurality of simplified receptacle terminals.

2. Description of the Related Art

In the prior art, spring terminal connector assembly includes plug connector and receptacle connector mating with each other. The plug connector includes a plug housing and a plurality of spring terminals attached to the plug housing, and the receptacle connector includes a receptacle housing and a plurality of receptacle terminals retained in the receptacle housing. The spring terminal is generally processed to a shape corresponding to the spring terminal and assembled into the receptacle housing to math the spring terminal of the plug connector. However, the design of the connector assembly should spend high cost and have low productivity.

Therefore, an improved electrical connector assembly is highly desired to meet overcome the requirement.

### BRIEF SUMMARY OF THE INVENTION

An object of the present invention is to provide an electrical connector assembly having a plurality of simplified receptacle terminals easily to be assembled.

In order to achieve above-mentioned object, an electrical connector assembly includes an receptacle connector, the receptacle connector includes a first insulative housing defining a mating surface and a first side surface extending along a first direction. A plurality of first terminals are retained in the first insulative housing and each defines a contacting plate fixed to the first insulative housing and a welding portion extending outside of the first insulative housing. The first insulative housing defines a plurality of mating holes running through the mating surface, a part of the contacting plate is exposed in the mating hole to form a contacting portion.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector assembly in accordance with the present invention;

FIG. 2 is an exploded perspective view of the electrical connector assembly shown in FIG. 1;

FIG. 3 is another exploded perspective view of the electrical connector assembly shown in FIG. 1;

FIG. 4 is a front view of a receptacle connector of the electrical connector assembly shown in FIG. 1; and

FIG. 5 is a cross-section view of the electrical connector assembly taken along line 5-5 of FIG. 1.

### DESCRIPTION OF PREFERRED EMBODIMENT OF THE INVENTION

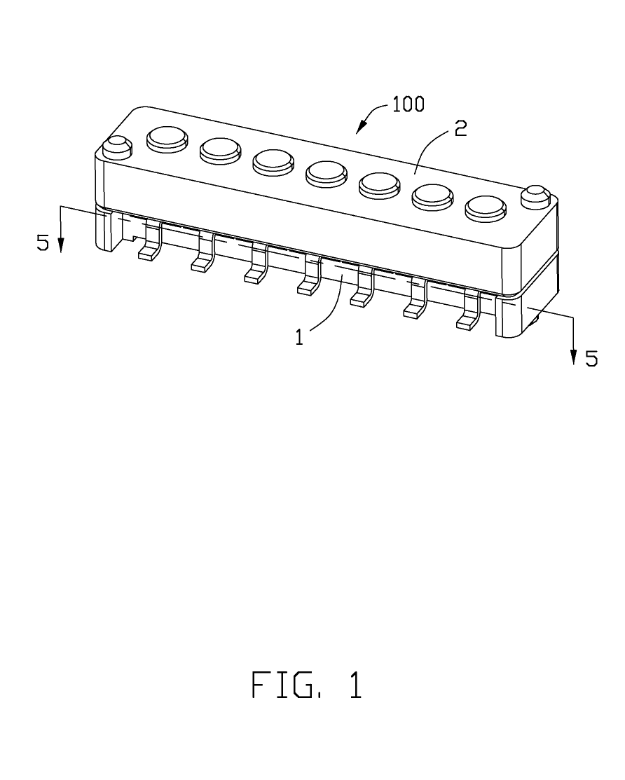

Reference will now be made to the drawing figures to describe a preferred embodiment of the present invention in detail. Referring to FIG. 1, an electrical connector assembly 100 in accordance with the present invention includes a receptacle connector 1 and a plug connector 2 mating with each other.

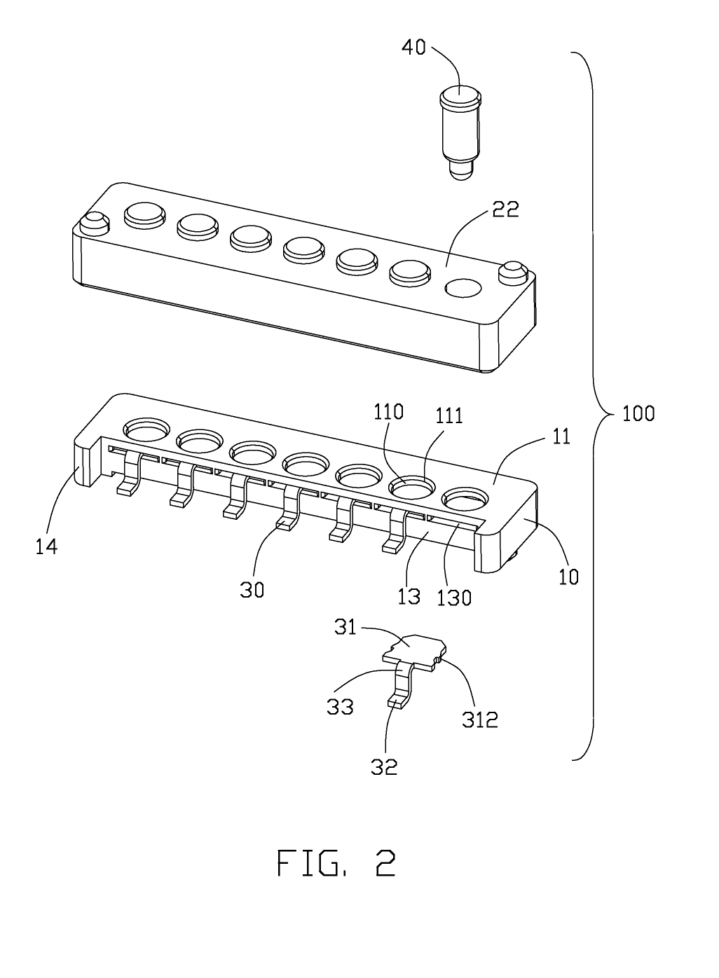

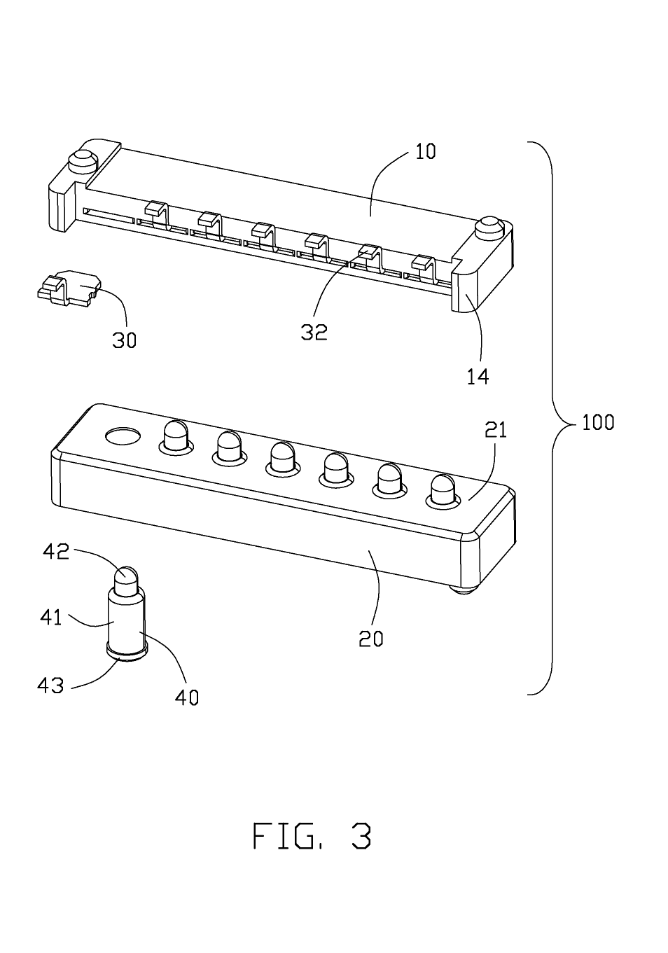

Referring to FIG. 2 and FIG. 3, the receptacle connector 1 includes a first insulative housing 10 extending along a longitudinal direction and a plurality of first terminals 30 inserted in the first insulative housing 10 and arranged along the longitudinal direction, wherein the longitudinal direction is defined as a first direction and a transverse direction perpendicular to the longitudinal direction is defined as a second direction. The first insulative housing 10 defines a mating surface 11, a first side surface 13 located on a lateral side of the mating surface 11 and a plurality of circular mating holes 110 running through the mating surface 11. The mating hole 110 defines a horn-shaped guiding edge 111 adjacent to the mating surface 11 and used for guiding the plug connector 2 inserted thereto. Each first terminal defines a contacting plate 31 fixed in the first insulative housing 10, a welding portion 32 extending outside of the first insulative housing 10 and a connecting portion 33 connecting the contacting plate 31 and the welding portion 32. The contacting plate 31 is disposed in the first insulative housing 10 with a part exposed in the mating hole 110 to be defined as a contacting portion, the connecting portion 33 and the welding portion 32 extend along the second direction.

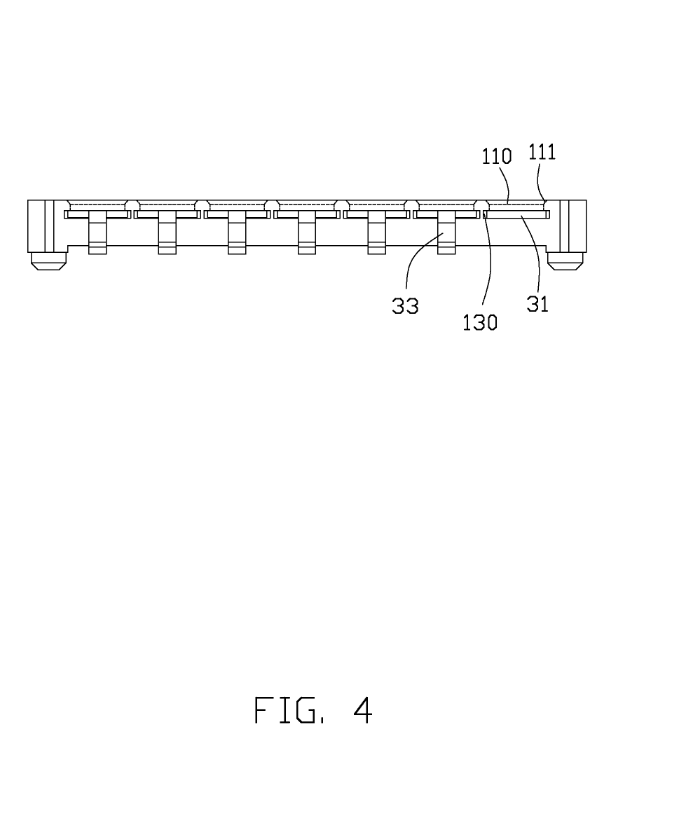

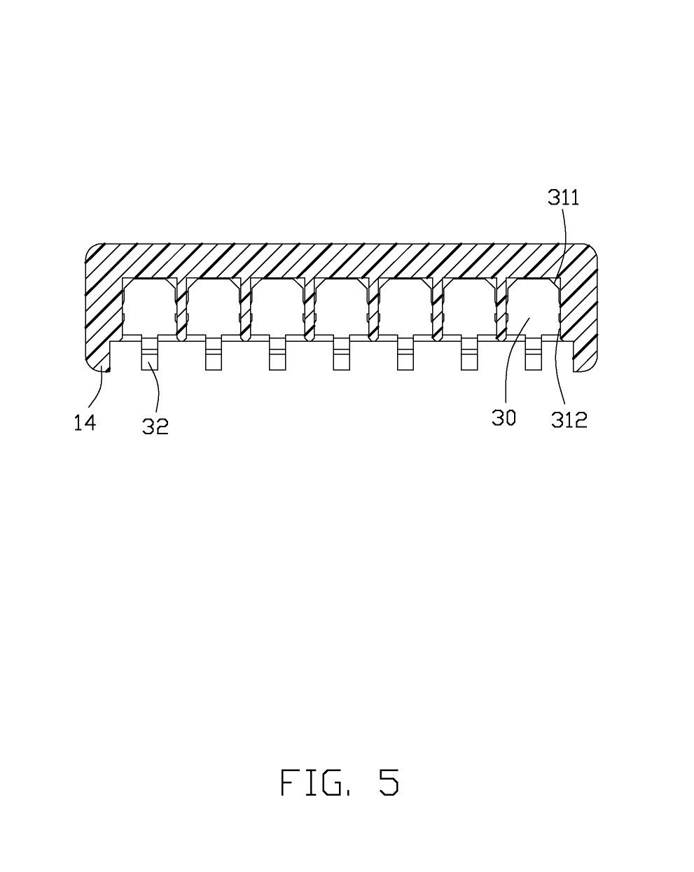

Referring to FIG. 4 to FIG. 5, the first insulative housing 10 defines a plurality of terminal slots 130 running through the first side surface 13 and a pair of protecting ribs 14 located on opposite sides of the first side surface 13 and extending along the second direction. The plurality of terminal slots 130 are arranged along the first direction and flush with each other, the width of the terminal slot 130 is greater than the diameter of the mating hole 110 in the first direction. The plurality of contacting plates 31 are inserted in corresponding terminal slots 130 and each contacting plate 31 defines a pair of guiding edges 311 and at least a pair of barbs 312 located on both sides of the contacting plate 31 in the second direction, the guiding edge 311 is used for guiding the contacting plate 31 to be inserted into the terminal slot 130 and the barb 312 makes it easy to fix the contacting 31 to the terminal slot 130. The contacting plate 31 is lower than the mating surface 110 in a third direction perpendicular to both the first direction and the second direction which means that the contacting surface of the contacting plate 31 close in the bottom of the mating holes 110. The pair of protecting ribs 14 locate on both sides of the welding portions 32 of the first terminals to prevent the welding portions of the first terminals from being damaged by improper operation.

Referring to FIG. 2 and FIG. 3, the plug connector 2 includes a second insulative housing 20 extending along the first direction and a plurality of second terminals 40 attached to the second insulative housing 20, the second insulative housing 20 defines an abutting surface 21 and a mounting surface opposite to each other. The second terminals 40 are elastic terminals and extend outside of the abutting surface 21 of the second insulative housing 20, each second terminal 40 defines a tubular main portion 41, a contacting portion 42 elasticity moving back-and-forth relative to the main portion 41 in the third direction and a soldering portion 43 located on the end of the main portion 41. The contacting portion 42 of the second terminal projects outside of the mating surface 21 of the second insulative housing 20 and the soldering portion 43 extends outside of the mounting surface 22 of the second insulative housing 20.

when the plug connector 2 mates with the receptacle connector 1, the second terminals 40 of the plug connector 2 are guided into the mating holes 110 of the receptacle connector 1 via the guiding edges 111 of the mating holes 110 so as to elastically and electrically connect the contacting portions of the first terminals 30 of the receptacle connector 1. It makes the connector assembly achieving electrically conduction while reduces the production and processing steps of the connector, thereby improving the productivity of the connector and reducing the manufacturing cost of the connector.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector assembly, comprising:
an receptacle connector comprising:
a first insulative housing defining a mating surface and a first side surface extending along a first direction; and
a plurality of first terminals retained in the first insulative housing and each defining a contacting plate fixed to the first insulative housing and a welding portion extending outside of the first insulative housing; wherein
the first insulative housing defines a plurality of mating holes running through the mating surface, a part of the contacting plate is exposed in the mating hole to form a contacting portion.

2. The electrical connector assembly as described in claim 1, wherein the first insulative housing defines a plurality of terminal slots running through the mating surface, the contacting plate is inserted in corresponding terminal slot, a connecting portion is defined between the contacting plate and the welding portion and extending along the first side surface.

3. The electrical connector assembly as described in claim 2, wherein the terminal slot extends along the first direction, the connecting portion and the welding portion extend along a second direction perpendicular to the first direction, and the contacting plate defines at least a pair of barbs located on both sides of the contacting plate in the second direction.

4. The electrical connector assembly as described in claim 3, wherein the first insulative housing defines a pair of protecting ribs located on both sides of the first side surface in the second direction, the protecting ribs are located on opposite sides of the welding portions of the first terminals.

5. The electrical connector assembly as described in claim 4, wherein the first terminals are flush with each other in the first direction.

6. The electrical connector assembly as described in claim 1, wherein the contacting plate is lower than the mating surface, and the contacting surface of the contacting plate close in the bottom of the mating hole.

7. The electrical connector assembly as described in claim 4, wherein the mating hole is circular shape, the width of the terminal slot in the first direction is greater than the diameter of the mating hole.

8. The electrical connector assembly as described in claim 4, wherein the mating hole defines a trumpet-shaped guiding edge adjacent to the mating surface, the contacting plate defines a pair of guiding notches.

9. The electrical connector assembly as described in claim 1, wherein the electrical connector assembly includes a plug connector mating with the receptacle connector, the receptacle connector defines a second insulative housing and a plurality of second terminals retained in the second insulative housing, the second insulative housing defines an abutting surface and a mounting surface opposite to each other, the second terminals are elastic terminals and extend outside of the abutting surface of the second insulative housing.

10. The electrical connector assembly as described in claim 9, wherein the second terminal defines a tubular main portion, a contacting portion elasticity moving relative to the main portion and a soldering portion located on the end of the main portion, the contacting portion of the second terminal is projecting outside of the mating surface of the second insulative housing and the soldering portion is extending outside of the mounting surface of the second insulative housing.

11. A receptacle connector comprising:
a first insulative housing defining a mating surface and a mating hole upwardly running through the mating surface; and
a first terminal defining a contacting plate retained in the first insulative housing and a welding portion extending outside of the first insulative housing from a first side surface;
wherein the contacting plate is disposed below the mating hole to cover the mating hole and provide a contacting portion exposed in the mating hole.

12. The receptacle connector as described in claim 11, wherein the mating hole defines a trumpet-shaped guiding edge adjacent to the mating surface.

13. The receptacle connector as described in claim 11, wherein the mating hole is circular shape, and the contacting plate closes in a whole bottom of the mating hole

14. An electrical connector assembly comprising:
a first connector including a first insulative housing defining a plurality of first passageways along a transverse direction while each of said first passageways extending along a vertical direction perpendicular to said vertical direction;
a plurality of first contacts disposed in the corresponding passageways, respectively, each of said first contacts defining a cylindrical body with a retractable head;
a second connector including a second insulative housing defining a plurality of second passageways extending along the vertical direction with corresponding openings communicating with an exterior, each of said openings being dimensioned corresponding to a diameter of the corresponding first contact which is adapted to be inserted into the corresponding second passageway;
a plurality of horizontal slots formed in the second housing and intersect with the corresponding second passageways, respectively, each of said slots defining a height in the vertical direction and a width in the transverse direction; and
a plurality of second contacts assembled to the second housing; wherein
each of said second contacts includes a horizontal contacting plate inserted into the corresponding slot and having dimensions in compliance with said height and said width so as to have the head of the first contact abut against the contacting plate of the corresponding second contact during mating.

15. The electrical connector assembly as claimed in claim 14, wherein each of said second contacts further includes a horizontal solder tails exposed outside of a side face of the second housing in a lateral direction perpendicular to both said vertical direction and said transverse direction.

16. The electrical connector assembly as claimed in claim 15, wherein said second housing further includes a pair of protecting ribs at two opposite ends in said transverse direction, and said pair of protecting ribs extend in said lateral direction to protect the solder tails therebetween in the transverse direction.

17. The electrical connector assembly as claimed in claim 14, wherein the first contact defines an expanded bottom flange upwardly abutting against a bottom surface of the first housing in the vertical direction.

18. The electrical connector as claimed in claim 14, wherein each of said horizontal slots extends through a corresponding side face of the second housing to communicate with the exterior in a lateral direction perpendicular to both said vertical direction and said transverse direction.
